(19) United States
(12) Patent Application Publication
(10) Pub. No.: US 2015/0235586 A1
(43) Pub. Date: Aug. 20, 2015

(54) Array Substrate, Method for Manufacturing Array Substrate, and Display Device

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Xin LI, Beijing (CN); Jian REN, Beijing (CN); Yang PEI, Beijing (CN); Zhenwei WANG, Beijing (CN); Bin LI, Beijing (CN); Ying ZHANG, Beijing (CN)

(21) Appl. No.: 14/488,662

(22) Filed: Sep. 17, 2014

(30) Foreign Application Priority Data
Feb. 17, 2014 (CN) 201410052962.1

(51) Int. Cl. G09G 3/18

(52) U.S. Cl. CPC G09G 3/18; G09G 2300/043

(57) ABSTRACT

The present invention relates to the field of display technology, and provides an array substrate, a method for manufacturing an array substrate, and a display device. The array substrate comprises a substrate, a data line, and a gate line and a pixel electrode formed sequentially on the substrate. The data line includes a fixed segment arranged on a same layer as, and spaced from, the gate line or the pixel electrode, and a connection segment electrically connected to the fixed segment. The present disclosure is possible to prevent the data line from being too close to the pixel electrode at the shift side, thereby to prevent a charging voltage for the pixel electrode from being affected by the capacitance effect and ensure the display quality of an image. In addition, no additional resistor is required, so it is able to reduce the power consumption.

### CROSS REFERENCE OF RELATED APPLICATIONS

The present application is based on and claims the benefit of priority of Chinese Patent Application No. 201410052962.1 filed on Feb. 17, 2014, the entire contents of which are hereby incorporated by reference.

### TECHNICAL FIELD

The present invention relates to the field of display technology, in particular to an array substrate, a method for manufacturing an array substrate, and a display device.

### BACKGROUND

In an existing TFT-LCD (liquid crystal display) panel, a data line and a pixel electrode are usually made of a metallic material on different two layers. Taking a display panel with an advanced super dimension switch (ADS) technique as an example, its core feature is forming a multidimensional electric field within an identical plane by means of an electric field produced at an edge of a slit electrode and an electric field produced between a slit electrode layer and a plate electrode layer, so as to rotate all alignment liquid crystal molecules that between the slit electrodes and those directly above the electrodes within a crystal liquid cell, thereby to improve the working efficiency of the liquid crystals and increase the light transmittance. Taking the display panel with the ADS mode as an example, as shown in FIG. 1, during the manufacture of an array substrate, a gate line 1 is formed on a substrate at first, and then a pixel electrode 2 and a data line 3 are subsequently formed from the bottom up with a gate line layer as a basis. A blank region is provided within the pixel electrode 2, and a common electrode 4 is provided at the blank region. On the array substrate, the pixel electrodes are provided at both sides of the data line.

During the manufacture, a pixel electrode layer and a data line layer are required to be aligned with the gate line layer, respectively, and the repeated alignment will easily shift the position of the pixel electrode layer relative to the data line layer, as shown in FIG. 2. In addition, the two metal layers may be shifted in different directions. The data line 3 is located between two pixel electrodes 2, and the distances between the data line 3 and the left and right pixel electrodes 2 are L1 and L2 respectively, as shown in FIG. 2. During the alignment, if the shift amount is sufficiently large, the data line 3 will be too close to a pixel electrode 4 at a shift side (e.g., L2 in FIG. 2) due to the deviation caused by fluctuations in a process or other causes. In FIG. 2, for example, the layers are shifted toward the right side. At this time, the capacitance effect will affect a charging voltage for the pixel electrode, and thereby affects the display quality of an image.

### SUMMARY

An object of the present invention is to prevent the deterioration of the display quality due to a shift of a data line.

In one aspect, the present invention provides an array substrate, comprising a substrate, a data line, and a gate line and a pixel electrode formed sequentially on the substrate. The data line includes a fixed segment arranged on a same layer as, and spaced from, the gate line or the pixel electrode, and a connection segment electrically connected to the fixed segment.

Further, two ends of the fixed segment of the data line are aligned with two ends of the pixel electrode, respectively.

Further, a gate insulating layer and a source/drain electrode layer are provided above the gate line, and the connection segment of the data line is arranged on a same layer as the source/drain electrode layer.

Further, when the fixed segment of the data line is arranged on a same layer as the gate line, the fixed segment of the data line is arranged spacing from the gate line, without overlapping each other.

Further, when the fixed segment of the data line is arranged on a same layer as the gate line, the connection segment of the data line is connected to the fixed segment of the data line through a via-hole penetrating through the gate insulating layer.

Further, the fixed segment of the data line is made of an identical material to the gate line.

Further, when the fixed segment of the data line is arranged on a same layer as the pixel electrode, the fixed segment of the data line is arranged spacing from the pixel electrode, without overlapping each other.

Further, when the fixed segment of the data line is arranged on a same layer as the pixel electrode, the connection segment of the data line is electrically lapped over the fixed segment of the data line directly.

Further, the fixed segment of the data line is made of an identical material to the pixel electrode.

In another aspect, the present invention provides a method for manufacturing an array substrate, comprising forming patterns of a gate line, a data line and a pixel electrode on a substrate. The pattern of the data line includes a fixed segment arranged on a same layer as, and spaced from, the gate line or the pixel electrode, and a connection segment electrically connected to the fixed segment of the data line.

Further, the step of forming the pattern of the gate line on the substrate comprises: forming the patterns of the gate line and the fixed segment of the data line on the substrate simultaneously by a patterning process.

Further, subsequent to forming the pattern of the gate line on the substrate, the method further comprises:

forming a gate insulating layer above the pattern of the gate line; and

forming patterns of source/drain electrodes and the connection segment of the data line above the gate insulating layer simultaneously by a patterning process.

Further, subsequent to forming the gate insulating layer above the pattern of the gate line, the method further comprises:

forming a via-hole that penetrates through the gate insulating layer, so as to the fixed segment is connected with the to-be-formed connection segment of the data line.

Further, subsequent to forming the pattern of the gate line on the substrate, the method further comprises:

forming the gate insulating layer above the pattern of the gate line; and

forming the patterns of the source/drain electrodes and the connection segment of the data line above the gate insulating layer simultaneously by a patterning process.

The step of forming the pattern of the pixel electrode on the substrate comprises:

forming the patterns of the pixel electrode and the fixed segment of the data line above the patterns of the source/drain electrodes and the connection segment of the data line simultaneously by a patterning process, the connection segment of the data line being electrically lapped over the fixed segment of the data line directly.

In yet another aspect, the present invention provides a display device comprising the above-mentioned array substrate.

According to the array substrate, the method for manufacturing the array substrate and the display device of the present invention, the data line is divided into two parts, i.e., the fixed segment and the connection segment, and the fixed segment is arranged on a same layer as the gate line or the pixel electrode while the connection segment is electrically connected to the fixed segment. It is merely required to carry out the alignment once with the layer on which the gate line is located, so as to reduce the number of times of the alignment, thereby to reduce the shift amount within a controllable range. As a result, it is able to prevent the data line from being too close to the pixel electrode at the shift side, thereby to prevent a charging voltage for the pixel electrode from being affected by the capacitance effect and ensure the display quality of an image. In addition, no additional resistor is required, so it is able to reduce the power consumption.

### BRIEF DESCRIPTION OF THE DRAWINGS

FIG. 1 is a planar view showing a part of an existing array substrate;

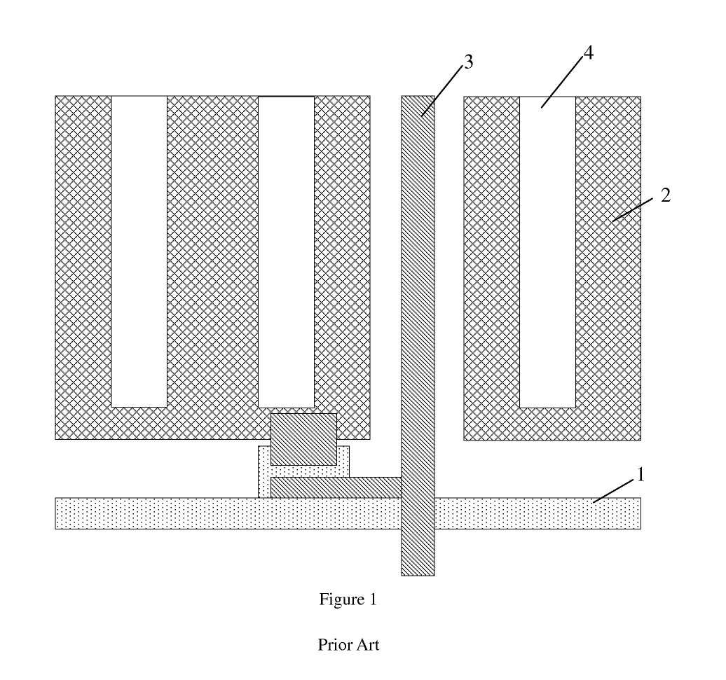

FIG. 2 is a schematic view showing the existing array substrate after a data line is shifted;

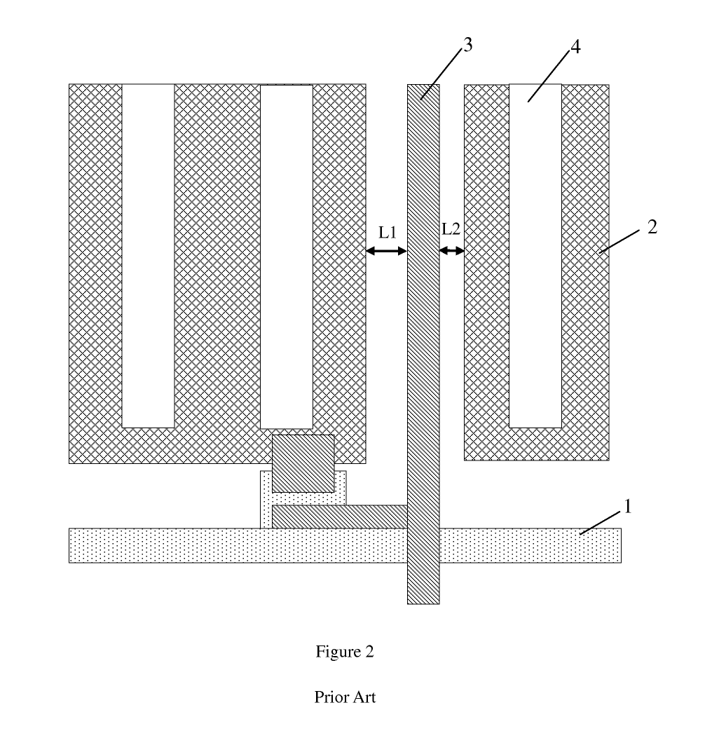

FIG. 3 is a schematic view showing an array substrate according to the first embodiment of the present invention;

FIG. 4 is a schematic view showing the array substrate when a connection segment of a data line is shifted according to the first embodiment of the present invention; and

FIG. 5 is a schematic view showing the array substrate according to the second embodiment of the present invention.

Wherein, 1. gate line; 2. pixel electrode; 3. data line; 31. fixed segment of data line; 32. connection segment of data line; 4. common electrode; 5. via-hole.

### DETAILED DESCRIPTION

The present invention will be described hereinafter in conjunction with the drawings and the embodiments. The following embodiments are for illustrative purposes only, but shall not be used to limit the scope of the present invention.

### The First Embodiment

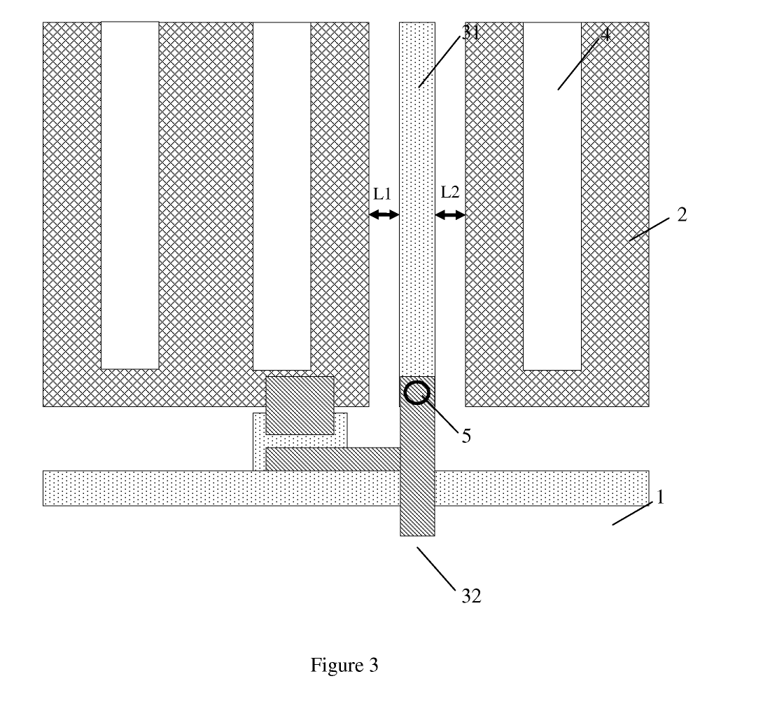

In this embodiment, an array substrate comprises a substrate, a data line 3, and a gate line 1 and a pixel electrode 2 formed sequentially on the substrate. The data line 3 includes a fixed segment 31 arranged on a same layer as, and spaced from, the gate line 31, and a connection segment 32 is electrically connected to the fixed segment 31, as shown in FIG. 3.

Preferably, two ends of the fixed segment 31 are aligned with two ends of the pixel electrode 2, respectively. It is to be noted that, the connection segment 32 of the data line merely serves as a connection end for connecting the fixed segment 31 of the data line and a driving circuit, and it is not located between the pixel electrodes 2, so no capacitance effect will be caused even if it is shifted during the manufacture.

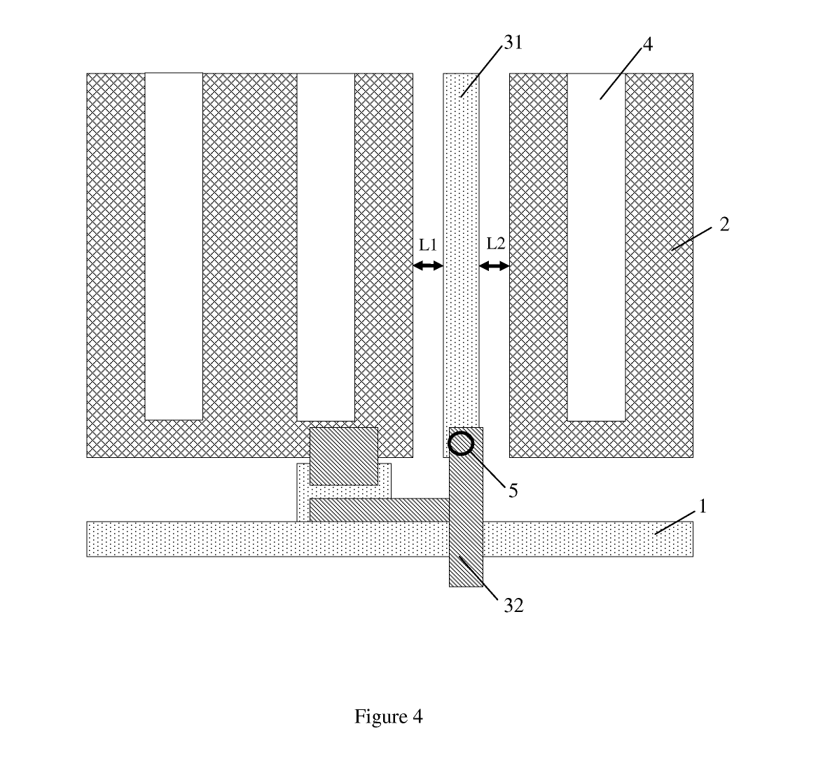

Referring to FIGS. 3 and 4, the distances between the fixed segment 31 of the data line and the pixel electrodes 2 at both sides are L1 and L2, respectively. During the alignment, as shown in the Figures, even if the connection segment 32 of the data line is shifted, the distances L1 and L2 will remain unchanged, and the fixed segment 31 of the data line will not be shifted. As a result, it is able to prevent the data line from being too close to the pixel electrode at the shift side, thereby to prevent a charging voltage for the pixel electrode from being affected by the capacitance effect, and ensure the display quality of an image, and improve the deterioration of the display quality.

When the fixed segment 31 of the data line is formed on a same layer as the gate line 1, a via-hole 5 is provided on a gate insulating layer above the gate line 1, at a position corresponding to a lapping segment of the fixed segment 31 of the data line, and the connection segment 32 of the data line is connected to the fixed segment 31 of the data line through the via-hole 5.

In order to reduce the process steps and the process complexity, the fixed segment 31 of the data line is made of an identical material to the gate line 1.

The fixed segment 31 and the connection segment 32 of the data line may, in accordance with the actual situations, be made of identical or different materials.

A method for manufacturing the array substrate will be described hereinafter. At first, the fixed segment of the data line and the gate line, which are made of an identical material, are formed on the substrate. To be specific, patterns of the gate line and the fixed segment of the data line are formed on the substrate simultaneously by a patterning process, and the fixed segment 31 of the data line is spaced from the gate line 1, without overlapping one another. Then, the gate insulating layer, a source/drain electrode layer, the pixel electrode 2 and the connection segment 32 of the data line are sequentially arranged on the substrate. To be specific, after the pattern of the gate line is formed on the substrate, the gate insulating layer is formed thereabove, and the patterns of the source/drain electrodes and the connection segment 32 of the data line are formed above the gate insulating layer simultaneously by a patterning process, so that the connection segment 32 of the data line is formed on a same layer as the source/drain electrode layer. Finally, after the gate insulating layer is formed above the pattern of the gate line, the via-hole that penetrates the gate insulating layer is formed, through which the fixed segment 31 of the data line and the to-be-formed connection segment 32 of the data line are connected with each other.

Since other layers on the substrate are aligned with each other with the layer where the gate line is located as a basis, therefore, in this embodiment, the fixed segment of the data line, which is aligned with the pixel electrode, is formed on a same layer as the gate line, so it is merely required to align the pixel electrode with the layer where the gate line and the fixed segment of the data line are located, and the alignment of the connection segment of the data line is not highly required. As a result, it is able to improve the shift amount within a controllable range and prevent the data line from being too close to the pixel electrode at the shift side, thereby to prevent the charging voltage for the pixel electrode from being affected due to the capacitance effect and ensure the display quality of the image. In addition, no additional resistor is required, so it is able to reduce the power consumption.

### The Second Embodiment

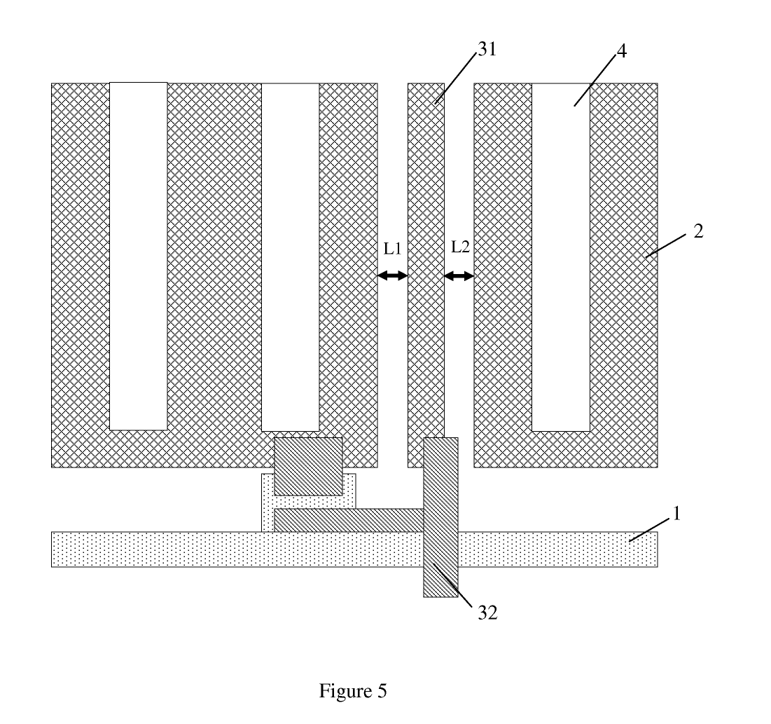

In this embodiment, the array substrate comprises a substrate, a data line, and a gate line and a pixel electrode formed sequentially on the substrate. The data line comprises a fixed segment and a connection segment. As shown in FIG. 5, the fixed segment 31 of the data line is arranged on a same layer as, and spaced from, the pixel electrode 2, and the connection segment 32 is electrically connected to the fixed segment 31 of the data line.

When the fixed segment of the data line is arranged on a same layer as the pixel electrode, there is no other layer between the pixel electrode and the connection segment 32, so the connection segment 32 of the data line can be electrically lapped over the fixed segment 31 of the data line directly. Of course, they may be connected to each other via any other electrical element.

For example, two ends of the fixed segment 31 are aligned with two ends of the pixel electrode 2, respectively. It is to be noted that, the connection segment 32 of the data line merely serves as a connection end for connecting the fixed segment 31 of the data line and a driving circuit, and it is not located between the pixel electrodes 2, so no capacitance effect will be caused even if it is shifted during the manufacture. As shown in FIG. 5, the distances between the fixed segment 31 and the pixel electrodes at both sides are L1 and L2, respectively. During the alignment, it can been seen from the figures, the fixed segment 31 of the data line will not be shifted even if the connection segment 32 of the data line is shifted.

In order to reduce the process steps and the process complexity, when the fixed segment 31 of the data line is formed on a same layer as the pixel electrode 2, the fixed segment 31 of the data line may be made of an identical material to the pixel electrode 2.

The fixed segment 31 and the connection segment 32 of the data line may, in accordance with the actual situations, be made of an identical or different materials.

A method for manufacturing the array substrate according to the embodiment will be described hereinafter. At first, a pattern of the gate line is formed on the substrate; secondly, a gate insulating layer is formed above the pattern of the gate line, and patterns of source/drain electrodes and the connection segment 32 of the data line are formed above the gate insulating layer simultaneously by a patterning process. Then, a pattern of the pixel electrode is formed on the substrate with the gate line 1. To be specific, patterns of the pixel electrode and the fixed segment 31 of the data line are formed above the patterns of the source/drain electrodes and the connection segment 32 of the data line simultaneously by a patterning process, and the fixed segment of the data line is arranged on a same layer as the pixel electrode, and having the fixed segment 31 of the data line and the pixel electrode being spaced from each other, and without overlapping one another. The connection segment 32 of the data line is electrically lapped over the fixed segment 31 of the data line directly.

Since other layers on the substrate are aligned with each other with the layer where the gate line is located as a basis, therefore, in this embodiment, the fixed segment of the data line that is aligned with the pixel electrode is formed on a same layer as the pixel electrode, so it is merely required to align the layer where the fixed segment of the data line and the pixel electrode are located with the layer where the gate line is located, and the alignment of the connection segment of the data line is not highly required. As a result, it is able to improve the shift amount within a controllable range and prevent the data line from being too close to the pixel electrode at the shift side, thereby to prevent the charging voltage for the pixel electrode from being affected due to the capacitance effect and ensure the display quality of the image. In addition, no additional resistor is required, so it is able to reduce the power consumption.

It is to be noted that, the fixed segments of the data lines may be arranged on the array substrate by combining the ways mentioned in the first and second embodiments, i.e., a plurality of the data lines may be arranged in different ways selected from either of the first and second embodiments. However, the process therefore may be more complex.

In addition, it is to be noted that, the pixel electrode in the above embodiments may be arranged above or below the connection segment of the data line (similar to all the data lines in the prior art), and the position relationship between the pixel electrode and the connection segment of the data line is not particularly defined in the present invention.

When the pixel electrode is arranged below the connection segment of the data line, the patterns of the pixel electrode and the fixed segment of the data line may be formed prior to the patterns of the source/drain electrodes and the connection segment of the data line. When the pixel electrode is arranged above the connection segment of the data line, the patterns of the source/drain electrodes and the connection segment of the data line may be formed prior to the patterns of the pixel electrode and the fixed segment of the data line.

The present invention further provides a display device comprising the above-mentioned array substrate.

According to the array substrate, the method for manufacturing the array substrate and the display device of the disclosure, the data line is divided into two parts, i.e., the fixed segment and the connection segment. The ends of the fixed segment of the data line are aligned with the ends of the pixel electrode, respectively, and the connection segment of the data line merely serves as the connection end for connecting the fixed segment of the data line and the driving circuit but not located between the pixel electrodes. Meanwhile, the fixed segment of the data line is arranged on a same layer as the gate line or the pixel electrode. It is merely required to carry out the alignment once with the layer on which the gate line is located, so as to reduce the number of times of the alignment, thereby to reduce the shift amount within a controllable range. As a result, it is able to prevent the data line from being too close to the pixel electrode at the shift side, thereby to prevent a charging voltage for the pixel electrode from being affected by the capacitance effect, ensure the display quality of an image. In addition, no additional resistor is required, so it is able to reduce the power consumption.

The above are merely the preferred embodiments of the present invention. It should be noted that, a person skilled in the art may make modifications and improvements without departing from the principle of the present invention, and these modifications and improvements shall be also considered as the scope of the present invention.

What is claimed is:

1. An array substrate, comprising a substrate, a data line, and a gate line and a pixel electrode formed sequentially on the substrate, the data line comprises a fixed segment arranged on a same layer as, and spaced from, the gate line or the pixel electrode, and a connection segment electrically connected to the fixed segment.

2. The array substrate according to claim 1, wherein
two ends of the fixed segment of the data line are aligned with two ends of the pixel electrode, respectively.

3. The array substrate according to claim 1, wherein
a gate insulating layer and a source/drain electrode layer are provided above the gate line, and
the connection segment of the data line is arranged on a same layer as the source/drain electrode layer.

4. The array substrate according to claim 3, wherein
when the fixed segment of the data line is arranged on a same layer as the gate line, the fixed segment of the data line is spacing from the gate line, and without overlapping each other.

5. The array substrate according to claim 3, wherein
when the fixed segment of the data line is arranged on a same layer as the gate line, the connection segment of the data line is connected to the fixed segment of the data line through a via-hole penetrating through the gate insulating layer.

6. The array substrate according to claim 5, wherein
the fixed segment of the data line is made of an identical material to the gate line.

7. The array substrate according to claim 3, wherein
when the fixed segment of the data line is arranged on a same layer as the pixel electrode, the fixed segment of the data line is spacing from the pixel electrode, and without overlapping each other.

8. The array substrate according to claim 3, wherein
when the fixed segment of the data line is arranged on a same layer as the pixel electrode, the connection segment of the data line is electrically lapped over the fixed segment of the data line directly.

9. The array substrate according to claim 8, wherein
the fixed segment of the data line is made of an identical material to the pixel electrode.

10. A method for manufacturing an array substrate, comprising forming patterns of a gate line, a data line and a pixel electrode on a substrate, wherein
the pattern of the data line comprises a fixed segment arranged on a same layer as, and spaced from, the gate line or the pixel electrode, and a connection segment electrically connected to the fixed segment of the data line.

11. The method according to claim 10, wherein
the step of forming the pattern of the gate line on the substrate comprises forming the patterns of the gate line and the fixed segment of the data line on the substrate simultaneously by one patterning process.

12. The method according to claim 11, wherein
subsequent to forming the pattern of the gate line on the substrate, the method further comprises:
forming a gate insulating layer above the pattern of the gate line; and
forming patterns of source/drain electrodes and the connection segment of the data line above the gate insulating layer simultaneously by one patterning process.

13. The method according to claim 12, wherein
subsequent to forming the gate insulating layer above the pattern of the gate line, the method further comprises:
forming a via-hole that penetrates through the gate insulating layer, so as to connect the fixed segment of the data line with the to-be-formed connection segment of the data line.

14. The method according to claim 10, wherein
subsequent to forming the pattern of the gate line on the substrate, the method further comprises:
forming the gate insulating layer above the pattern of the gate line;
forming the patterns of the source/drain electrodes and the connection segment of the data line above the gate insulating layer simultaneously by one patterning process, and
the step of forming the pattern of the pixel electrode on the substrate comprises:
forming the patterns of the pixel electrode and the fixed segment of the data line above the patterns of the source/drain electrodes and the connection segment of the data line simultaneously by a patterning process, the connection segment of the data line being electrically lapped over the fixed segment of the data line directly.

15. A display device comprising the array substrate according to claim 1.

16. The display device according to claim 15, wherein
two ends of the fixed segment of the data line are aligned with two ends of the pixel electrode, respectively.

17. The display device according to claim 15, wherein
a gate insulating layer and a source/drain electrode layer are provided above the gate line, and
the connection segment of the data line is arranged on a same layer as the source/drain electrode layer.

18. The display device according to claim 17, wherein
when the fixed segment of the data line is arranged on a same layer as the gate line, the fixed segment of the data line is spacing from the gate line, and without overlapping each other.

19. The array substrate according to claim 17, wherein
when the fixed segment of the data line is arranged on a same layer as the gate line, the connection segment of the data line is connected to the fixed segment of the data line through a via-hole penetrating through the gate insulating layer.

20. The array substrate according to claim 19, wherein
the fixed segment of the data line is made of an identical material to the gate line.
